(19) United States
(12) Patent Application Publication
(10) Pub. No.: US 2015/0120803 A1
(43) Pub. Date: Apr. 30, 2015

(54) Method and Device for Relaying Time-Triggered and Event-Triggered Communications

(71) Applicant: FTS Computertechnik GmbH, Wien (AT)

(72) Inventors: Harald Angelow, Wien (AT); Günther Bauer, Wien (AT); Wilfried Steiner, Wien (AT); Martin Schwarz, Wiener Neustadt (AT)

(73) Assignee: FTS Computertechnik GmbH

(21) Appl. No.: 14/397,809

(22) PCT Filed: May 14, 2013
(86) PCT No.: PCT/AT2013/050107

§ 371 Date: Oct. 29, 2014

(30) Foreign Application Priority Data
May 15, 2012 (AT) A 577/2012

(51) Int. Cl. H04L 12/863; H04L 12/24

(52) U.S. Cl. CPC H04L 47/50; H04L 41/06
USPC 709/202

(57) ABSTRACT

The invention relates to a method for distributing event-triggered (ET) and time-triggered (TT) messages in a distributed real-time system by means of a distributor unit that comprises a low-level relay unit (LLVME) and a high-level relay unit (HLVME), wherein communication ports of the distributor unit to other relay units and/or end systems of the real-time systems are attached to the LLVME. The invention further relates to such a distributor unit and to a real-time system comprising such a distributor unit. According to the invention, the LLVME has access to a global time base and is configured to differentiate between ET messages and TT messages, wherein the LLVME forwards an ET message that is incoming at one of its ports to the HLVME such that the HLVME can carry out the analysis and temporal scheduling of said ET message before it delivers this ET message back to the LLVME for issue at the designated output ports of the LLVME, and, prior to the known issuing of a TT message, the LLVME transmits a pause frame to the HLVME such that no ET message is scheduled to be transmitted by the HLVME during this anticipated and scheduled TT message transmission slot, and wherein the LLVME delivers an incoming TT message directly for issue at the designated output ports in accordance with the known time plan.

The invention relates to a method for distributing event-triggered (ET) and time-triggered (TT) messages in a distributed real-time system by means of a distributor unit that comprises a low-level relay unit (LLVME) and a high-level relay unit (HLVME), wherein communication ports of the distributor unit to other relay units and/or end systems of the real-time systems are attached to the LLVME.

The invention further relates to a method for distributing event-triggered (ET) and time-triggered (TT) messages in a distributed real-time system, wherein the distributor unit comprises a low-level relay unit (LLVME) and a high-level relay unit (HLVME), wherein communication ports of the distributor unit to other relay units and/or end systems of the real-time system are attached to the LLVME.

The invention further relates to a distributed real-time system comprising at least one, e.g., exactly one such distributor unit.

The present invention belongs in the field of computer engineering. It describes an innovative method, by means of which event-triggered and time-triggered messages can be relayed in a distributed real-time system.

In distributed real-time systems, the required time conditions between the sensor inputs of a technical process and the outputs to the actuators of the technical process can be adhered to exactly if the communication between the computer nodes of the distributed real-time system takes place in a time-triggered manner [1]. In the prevailing, non-time-critical communication systems, e.g., in Ethernet, communication is carried out using the event-triggered approach.

The object of the present invention is to provide a solution to the problem of how to cost-effectively expand an existing event-triggered message distributor unit in order to also relay time-triggered messages.

This problem is solved with an initially mentioned method and with an initially mentioned distributor unit by virtue of the fact that the LLVME has access to a global time base and is configured to differentiate between ET messages and TT messages, wherein the LLVME forwards an ET message that is incoming at one of its ports to the HLVME such that the HLVME can carry out the analysis and temporal scheduling of said ET message before it delivers this ET message back to the LLVME for issue at the designated output ports of the LLVME, and, prior to the known issuing of a TT message, in particular in a timely manner, the LLVME transmits a pause frame to the HLVME such that no ET message is scheduled to be transmitted by the HLVME during the anticipated and scheduled TT message transmission slot, and wherein the LLVME delivers an incoming TT message directly for issue at the designated output ports in accordance with the known time plan.

According to the invention, it is therefore assumed that a message distributor unit comprises two subsystems, namely a low-level relay unit (LLVME), which has a global time, and a high-level relay unit (HLVME), which does not need to have access to a global time and can relay event-triggered messages. The LLVME contains the communication ports, via which the end systems (computer nodes) or further message distributor units are attached. A message that is incoming via a communication port of the LLVME is analyzed in the LLVME in order to determine whether the message belongs to the class of event-triggered messages or to the class of time-triggered messages. An event-triggered message is forwarded to the HLVME to be relayed. The HLVME analyzes the message and decides, with consideration for the current message traffic, at which point in time the message will be transferred from the HLVME to the LLVME for issue at the designated output port of the LLVME.

A time-triggered message is forwarded by the LLVME directly at the designated output port in accordance with the time plan for time-triggered messages stored in the LLVME. In order to ensure that the designated output port is not occupied by an event-triggered message at the a priori known transmission time of the time-triggered message, the LLVME transmits a pause frame to the HLVME in a timely manner such that the HLVME does not schedule the output port at the time of the transmission of the time-triggered message.

A few additional concepts that are used in the present document will be explained in the following. A message is time-triggered (TT) if the transmission time of the periodic message is set in an a priori known time plan. A message is event-triggered (ET) if the transmission time of the message is set according to the best effort principle [4, page 175]. A pause frame is a message that is transmitted by the LLVME to the HLVME in order to instruct the HLVME not to transmit any further messages to the LLVME for relay during the time interval stated in the pause frame. The time interval between the transmission of the pause frame by the LLVME and the latest onset of the pause is referred to as activation jitter. In order to ensure that the designated output port of the LLVME is free at the transmission time of an a priori known time-triggered message, the interval between the transmission of the pause frame by the LLVME to the HLVME and the planned transmission time of the message must correspond to the activation jitter.

Since the structure and function of the pause frame is specified in the IEEE Standard 802.3 for Ethernet messages, the present invention makes it possible to expand existing Ethernet message distributor units for event-triggered messages that correspond to the IEEE standard in a cost-effective manner by adding a LLVME for the transmission of time-triggered messages without the need to make changes to the existing Ethernet message distributor unit. Since some of the existing message distributor units are implemented in an ASIC and making changes to an ASIC is very costly, the invention has great economic significance.

The subdivision of a message distributor unit into two hierarchically arranged subsystems, wherein the lower subsystem carries out the direct switching and the higher-level subsystem decides the sequence in which the messages should be relayed, is already prior art and is described, inter alia, in [3]. However, the prior art does not provide any information that suggests the approach provided according to the invention for integrating time-triggered and event-triggered message switching.

The above-described invention therefore discloses a method for expanding an existing message distributor unit for event-triggered messages (e.g., for Ethernet messages) in order to also relay time-triggered messages. According to the invention, a low-level relay unit is installed upstream of the existing message distributor, said low-level relay unit relaying the time-triggered messages and ensuring that the designated output port of the time-triggered message is not occupied by an event-triggered message at the a priori planned transmission time of the time-triggered message.

Further advantageous embodiments of the method according to the invention and of the distributor unit according to the invention are the following:

*) the LLVME transmits the pause frame to the HLVME at the pause frame transmission time, wherein the pause frame transmission time is determined from the planned transmission time of the time-triggered message minus the implementation-dependent activation jitter, which is known a priori, in particular; and/or

*) the duration of the pause called for by means of the pause frame is determined by the sum of the activation jitter plus the maximum transmission time of the time-triggered message, which is known a priori, in particular; and/or

*) a copy of a time-triggered message is forwarded by the LLVME to the HLVME for monitoring purposes; and/or

*) the structure and function of the pause frame correspond to the IEEE Standard 802.3; and/or

*) the LLVME transmits the pause frame to the HLVME at the pause frame transmission time only if a corresponding TT frame has arrived in the LLVME at the pause frame transmission time; and/or

*) the time plan applicable to the time-triggered messages is loaded into the LLVME by means of a cryptographically secured protocol; and/or

*) the time plan stored in the LLVME is secured by error-detecting codes; and/or

*) the time plan stored in the LLVME is secured by error-correcting codes.

The invention is explained in greater detail in the following by reference to the drawings. In the figures:

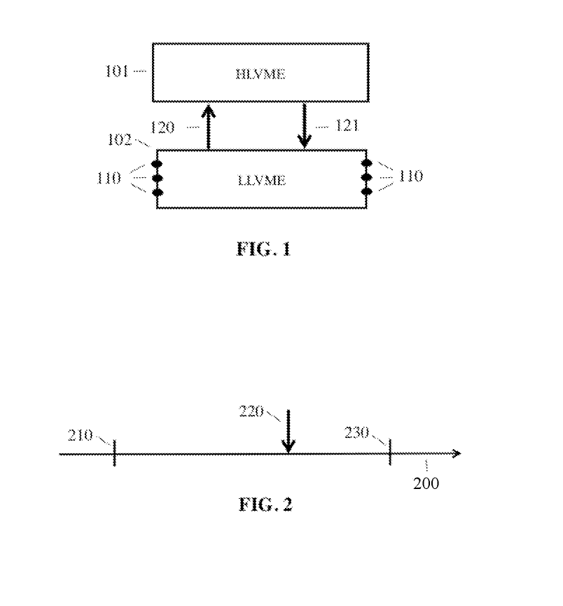

FIG. 1 shows the structural design of the expanded message distributor unit, and

FIG. 2 shows the timing of the transmission of a pause frame.

The following specific example is one of the many possible embodiments of the new method.

FIG. 1 shows a message distributor unit comprising the low-level relay unit (LLVME) 102 and the high-level relay unit (HLVME) 101. According to the invention, the LLVME 102 has access to the global time with known precision [4, page 56]. This global time can be set up according to the IEEE Standard 1588 or by means of another, manufacturer-dependent synchronization procedure. At the bidirectional communication ports 110 of the LLVME 102, the messages to be relayed arrive and the relayed messages are issued. Immediately after a message arrives via one of the communication ports 110, the LLVME 102 decides whether the incoming message is an ET message or a TT message. This decision must be unambiguous. It can be based on different pieces of information. In the simplest case, the contents of a dedicated message field in the header of the message, such as the Ethernet type field [2], indicates whether the message is a TT message or an ET message. It is also possible, however, for this decision to be made within the framework of an analysis of the MAC addresses, the port addresses or the time of arrival of a message, or the contents of a dedicated message field (or a combination of the aforementioned pieces of information). The TT Ethernet Standard [5] specifies methods for identifying a time-triggered message. If the incoming message is an ET message, it is forwarded via the powerful communication channel 120 to the HLVME for processing. The HLVME considers the message type and the current traffic volume and decides when to transmit this message to the LLVME via the powerful communication channel 121 so that the LLVME can issue the message via the designated port address 110. The HLVME can also perform monitoring functions in order to collect information on the traffic volume, the capacity utilization of the communication channels, and any errors that may be present.

If the LLVME 102 classifies a message as time-triggered, the message is then issued directly by the LLVME at the designated communication port of the LLVME at the planned issuance time according to the time plan stored in the LLVME. The time plan must be loaded into the LLVME before time-triggered messages are relayed. In order to ensure that the time plan was acquired from an authorized entity in an uncorrupted state, the loading of a new time plan can be secured by means of cryptographic protocols. The storage of the time plan can be secured within the LLVME by means of error-detecting or error-correcting codes.

In order to ensure that the designated communication port is not occupied by an event-triggered message at the time of issuance of a time-triggered message via this designated communication port of the LLVME 102, the LLVME must request a pause from the HLVME in a timely manner by means of a pause frame before the transmission of a time-triggered message. Such a pause frame has been standardized in the IEEE Standard 802.3.

FIG. 2 shows the timing of the transmission of the pause frame that ensures the timeliness of the pause. The progression of time is plotted on the abscissa 200 in FIG. 2. According to the time plan stored in the LLVME, the transmission of the time-triggered message from the LLVME via the designated output port 110 should begin at the a priori known time 230. At this time, the designated output port of the LLVME must be free for the transmission of the time-triggered message. We refer to the sum of the transmission time of the pause frame from the LLVME to the HLVME plus the maximum processing time of the pause frame in the HLVME plus the duration of the longest ET message to be transmitted at the designated output port as the activation jitter of the pause frame. The timeliness of the transmission of the pause frame from the LLVME to the HLVME is given when the interval between the pause frame transmission time 210 and the designated transmission time 230 of the time-triggered message corresponds to the activation jitter.

In a time-triggered schedule having low laxity, the case depicted in FIG. 2 can occur, in which the time-triggered message does not arrive at the LLVME until the time 220. On the basis of the information stored in the time plan of the LLVME and on the basis of the duration of the activation jitter known by the LLVME, the LLVME must request the pause from the HLVME at the pause frame transmission time 210 before this arrival 220 of the time-triggered message.

As an alternative, the laxity in the time-triggered schedule can be expanded such that the pause frame does not need to be transmitted until after the message arrives at the LLVME. This has the advantage that a pause does not need to be requested if a time-triggered message does not arrive.

The duration of the pause contained in the pause frame must be selected such that the longest time-triggered message to be transmitted has been transmitted before the end of the pause. According to the invention, the structure and the function of the pause frame can correspond to the IEEE Standard 802.3.

The LLVME will transmit the time-triggered messages to the HLVME even if the intent is to incorporate time-triggered messages into the monitoring functions. After the HLVME has analyzed a time-triggered message (in order to obtain the desired monitoring information), the HLVME discards the time-triggered message.

The above-described method for integrating time-triggered and event-triggered messages can be implemented, preferably, in the software of a CPU, as logic in a FPGA component, or as a standalone ASIC component.

The present invention therefore discloses a method for expanding an existing message distributor unit for event-triggered messages (e.g., for Ethernet messages) in order to also relay time-triggered messages. According to the invention, a low-level relay unit is installed upstream of the existing message distributor, said low-level relay unit relaying the time-triggered messages and ensuring that the designated output port of the time-triggered message is not occupied by an event-triggered message at the a priori planned transmission time of the time-triggered message.

### LITERATURE CITATIONS

[1] U.S. Pat. No. 5,694,542 Kopetz, H. Time-triggered communication control unit and communication method. Granted Dec. 2, 1997.

[2] U.S. Pat. No. 7,839,868. Kopetz, H. Communication method and system for the transmission of time-driven and event-driven Ethernet messages. Granted Nov. 23, 2010.

[3] US 2007/0083622 Wang et al. Ethernet Switch and Service Processing Method thereof. Pub. Date Apr. 12, 2007.

[4] Kopetz, H. Real-Time Systems, Design Principles for Distributed Embedded Applications. Springer Verlag. 2011.

[5] SAE Standard AS6802 von TT Ethernet. URL: http://standards.sae.org/as6802

[6] IEEE 802.3 Ethernet Standard. URL: http://www.ieee802.org/3/

[7] IEEE 1588 Standard for a Precision Clock Synchronization Protocol for Network Measurement and Control Systems. URL: http://www.ieee1588.com/

1. A method for distributing event-triggered (ET) and time-triggered (TT) messages in a distributed real-time system by means of a distributor unit that comprises a low-level relay unit (LLVME) and a high-level relay unit (HLVME), wherein communication ports of the distributor unit to other relay units and/or end systems of the real-time system are attached to the LLVME,
characterized in that
the LLVME has access to a global time base and is configured to differentiate between ET messages and TT messages, wherein the LLVME forwards an ET message that is incoming at one of its ports to the HLVME such that the HLVME can carry out the analysis and temporal scheduling of said ET message before it delivers this ET message back to the LLVME for issue at the designated output ports of the LLVME, and, prior to the known issuing of a TT message, in particular in a timely manner, the LLVME transmits a pause frame to the HLVME such that no ET message is scheduled to be transmitted by the HLVME during this anticipated and scheduled TT message transmission slot, and wherein the LLVME delivers an incoming TT message directly for issue at the designated output ports in accordance with the known time plan.

2. The method according to claim 1, characterized in that the LLVME transmits the pause frame to the HLVME at the pause frame transmission time, wherein the pause frame transmission time is determined from the planned transmission time of the time-triggered message minus the implementation-dependent activation jitter, which is known a priori, in particular.

3. The method according to claim 1, characterized in that the duration of the pause called for by means of the pause frame is determined by the sum of the activation jitter plus the maximum transmission time of the time-triggered message, which is known a priori, in particular.

4. The method according to claim 1 characterized in that a copy of a time-triggered message is forwarded by the LLVME to the HLVME for monitoring purposes.

5. The method according to claim 1, characterized in that the structure and function of the pause frame correspond to the IEEE Standard 802.3.

6. The method according to claim 1, characterized in that the LLVME transmits the pause frame to the HLVME at the pause frame transmission time only if a corresponding TT frame has arrived in the LLVME at the pause frame transmission time.

7. The method according to claim 1, characterized in that the time plan applicable to the time-triggered messages is loaded into the LLVME by means of a cryptographically secured protocol.

8. The method according to claim 1, characterized in that the time plan stored in the LLVME is secured by error-detecting codes.

9. The method according to claim 1, characterized in that the time plan stored in the LLVME is secured by error-correcting codes.

10. A distributor unit for distributing event-triggered (ET) and time-triggered (TT) messages in a distributed real-time system, wherein the distributor unit comprises a low-level relay unit (LLVME) and a high-level relay unit (HLVME), wherein communication ports of the distributor unit to other relay units and/or end systems of the real-time system are attached to the LLVME,
characterized in that
the LLVME has access to a global time base and is configured to differentiate between ET messages and TT messages, wherein the LLVME forwards an ET message that is incoming at one of its ports to the HLVME such that the HLVME can carry out the analysis and temporal scheduling of said ET message before it delivers this ET message back to the LLVME for issue at the designated output ports of the LLVME, and, prior to the known issuing of a TT message, in particular in a timely manner, the LLVME transmits a pause frame to the HLVME such that no ET message is scheduled to be transmitted by the HLVME during this anticipated and scheduled TT message transmission slot, and wherein the LLVME delivers an incoming TT message directly for issue at the designated output ports in accordance with the known time plan.

11. The distributor unit according to claim 10, characterized in that the LLVME transmits the pause frame to the HLVME at the pause frame transmission time, wherein the pause frame transmission time is determined from the planned transmission time of the time-triggered message minus the implementation-dependent activation jitter, which is known a priori, in particular.

12. The distributor unit according to claim 10, characterized in that the duration of the pause called for by means of the pause frame is determined by the sum of the activation jitter plus the maximum transmission time of the time-triggered message, which is known a priori, in particular.

13. The distributor unit according to claim 10, characterized in that a copy of a time-triggered message is forwarded by the LLVME to the HLVME for monitoring purposes.

14. The distributor unit according to claim 10, characterized in that the structure and function of the pause frame correspond to the IEEE Standard 802.3.

15. The distributor unit according to claim 10, characterized in that the LLVME transmits the pause frame to the HLVME at the pause frame transmission time only if a corresponding TT frame has arrived in the LLVME at the pause frame transmission time.

16. The distributor unit according to claim 10, characterized in that the time plan applicable to the time-triggered messages is loaded into the LLVME by means of a cryptographically secured protocol.

17. The distributor unit according to claim 10, characterized in that the time plan stored in the LLVME is secured by error-detecting codes.

18. The distributor unit according to claim 10, characterized in that the time plan stored in the LLVME is secured by error-correcting codes.

19. A distributed real-time system comprising at least one distributor unit according to claim 10.
